(19) United States
(12) Patent Application Publication
(10) Pub. No.: US 2011/0211785 A1
(43) Pub. Date: Sep. 1, 2011

(54) More Durable Bearing & Oil Seal Design For The GM 700R4 Family of Automatic Transmissions

(76) Inventor: Luther Preston Deans, Clayton, NC (US)

(21) Appl. No.: 13/036,868

(22) Filed: Feb. 28, 2011

Related U.S. Application Data
(60) Provisional application No. 61/308,413, filed on Feb. 26, 2010.

(51) Int. Cl. F16C 33/72

(52) U.S. Cl. 384/607

(57) ABSTRACT

The present invention relates to automatic transmissions. In particular, the present invention relates to the GM 700r4 automatic transmission. More particularly, the invention relates to a novel bearing/oil seal designed to replace the OEM input to output oil seal in the GM 700r4 transmission which is known to have oil seal failure history. The OEM input and output shafts of transmissions produce substantial movement relative to each other. Excessive movement between the shafts causes rapid oil seal wear, oil loss, and transmission failures. The new bearing/oil seal design of the present invention serves to couple the shafts together, and provide a vertical sealing face for a more durable seal. The benefits from the new bearing/oil seal are less movement throughout the drive train, longer oil seal life, less binding of the ¾ clutch pack, longer transmission shelf life, and increasing overall durability.

### REFERENCE TO RELATED APPLICATIONS

This patent application claims the benefit of U.S. Provisional Application No. 61/308,413 filed on Feb. 26, 2010, the disclosure of which is incorporated herein by reference in its entirety.

### BACKGROUND OF THE INVENTION

1. Field of the Invention

The present invention relates generally to automatic transmissions, and more specifically to the GM 700r4 /4160e family of automatic transmissions.

2. Description of Related Art

Since GM first introduced the four speed automatic overdrive in the Corvette in 1982, the 700r4 had many failures; the factory made improvements every year along with the aftermarket transmission improvement industry as disclosed in U.S. Pat. Nos. 5,503,601; 7,195,578; 7,527,577; 7,608,010; and U.S. PreGrant Pub. Nos. 2006/0122027; 2008/0167157; 2009/0258753; and 2010/0210408.

One of a few remaining problems is the premature wearing of the small rear stator bearing and input to output oil seal. The GM 700r4 thru 4170e family of automatic transmissions is known to have rapid input to output oil seal wear {due to the rear stator bearing wear}. The premature input to output oil seal wear caused many transmission failures from the lack of lubrication. Failure of this oil seal is observed during overhauls with low mileage that was due to other problems, for example four wheel drives with large tires can cause breakage to planetary gears due to torque. During these low mileage rebuilds, many observations show the seal is leaking at 40,000 miles and at 75,000 miles completely worn out. Transmission life at 60,000 becomes very questionable, especially at highway speeds in overdrive, towing and long trips.

The rapid input to output oil seal wear is due to design; it may be caused by excess movement between input and output shafts. The stator bearing has many functions one of which is supporting the input shaft (turbine shaft). This small bearing fails rapidly due to the heavy overhanging loads from the input shaft housing being on the very end of the shaft. The outer circumference of the oil seal is connected to the input shaft and inner circumference of the seal is connected to the output shaft. As the stator bearing wears, the input shaft has increasing movement; excess movement of both input and output shafts crushes the oil seal between the two shafts causing oil leakage, eventually causing transmission failures from the lack of lubrication.

The shaft bearing wear will also cause alignment binding problems to the clutch packs, especially the ¾ clutch. One side of the ¾ clutch (steel plates) is connected to the input shaft and the other side to the output shaft (friction plates). When the clutch is engaged between the input and output shafts, excess bearing clearance can cause binding. This happens to the ¾ clutch often, causing failure.

Therefore, there is an obvious need to have a solution to overcome the aforementioned problems such as premature of oil seal, oil leakage, transmission failure, and ¾ clutch alignment binding problems.

### SUMMARY OF THE INVENTION

One object of the invention is to provide a new bearing that couples with both shafts together to control movement of both shafts and provide two vertical sealing faces between input & output shafts.

Another object of the invention is to provide a new vertical seal that can reduce the lubrication oil leakage.

Yet another object of the invention is to provide a new bearing that can reduce the movement throughout the drive train and reduce the binding of ¾ clutch pack so as to increase overall durability.

Still another object of the invention is to provide a new oil seal that can replace the input to output oil seal with or without modification of OEM automatic transmissions. The bearing or oil seal can be employed during rebuilding of transmissions.

Still another object of the invention is to provide an automatic transmission that utilizes the new bearing & oil seal so as to extend the life of the automatic transmissions.

The present invention overcomes the aforementioned transmission failures due to the premature wear of small stator bearing and input to output shaft oil seal such as oil leakage, transmission failure, and ¾ clutch alignment binding problems.

The present invention provides for an improved bearing & oil seal design to replace currently used oil seals. The improved bearing and oil seal design can be used in place of currently used input to output oil seals. The OEM input and output shafts of transmissions produce substantial movement relative to each other because of premature wear of stator bearing. Excessive movement between the shafts causes rapid oil seal wear and oil loss problems. The new bearing & oil seal design of the present invention serves to help eliminate the excessive movement between the shafts and provide a vertical sealing face for a more durable seal.

The new bearing & oil seal of the present invention may be installed in the same location of the OEM input to output oil seal for coupling both shafts together to control movement. This will improve shaft bearing wear, oil seal wear, and clutch binding problems.

The new oil seal design is to place an oil seal with two vertical disks in contact with each other to control oil leakage. One of the vertical faces can be on the input shaft and the other on the output shaft to make an effective seal. Since both the input to output shafts have constant horizontal movements one of the vertical sealing faces would need to make constant horizontal movements to keep the vertical faces in contact. The two vertical faces can be compressed against each other by the lube oil pressure differential between the disks or other mechanisms known in the art. The center of each disk would have an orifice for lubrication oil to pass between the input and output shafts. One of the disks may have a larger orifice than the other to regulate increased shafts misalignment, oil leakage and oil restriction thru the orifice.

In one embodiment the bearing may be placed in the input housing (as the original oil seal) between input and output shafts. There are several combinations using two vertical disks with spring loading.

In another embodiment, the end of the input shaft is modified by boring a hole of 0.250 in depth and 0.900 in diameter. In this hole a piston with a center hole can be installed. The piston may serve as the vertical face oil seal for the input shaft. The piston may redirect the lube oil passageway in the input shaft to the center of the piston to pass oil into the center of the output shaft vertical seal face. The oil pressure differential between the back and front of the piston keeps the vertical surfaces in contact. The pressure differential is due to the output shaft lube orifices in the output shaft, thus the piston keeps force at all times on the vertical sealing faces.

The benefit from coupling the shafts together with a bearing is less movement throughout the drive train increasing overall durability. The ¾ clutch pack will have less binding, increasing the durability. Therefore, even after the rear stator bearing wears the vertical oil seal of the new bearing & oil seal according to the present invention will tolerate larger side movements than the original oil seal. Longer oil seal life will maintain lubrication thru drive train, especially the rear planetary gears which have a high failure rate due to insufficient lubrication.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows a perspective view of an embodiment of the invention installed between input shaft assembly and output shaft assembly (planet gear assembly has been intentionally omitted for clarity).

FIG. 2 shows an exploded perspective view of the embodiment of FIG. 1, with a planet gear assembly.

FIG. 3 shows a perspective view of the embodiment of embodiment of FIG. 2.

FIG. 4 shows a sectional view of the embodiment of the invention taken along line 4-4 in FIG. 1 (the spray assembly has been intentionally omitted for clarity).

FIG. 5 shows a sectional view of the embodiment of the invention taken along line 5-5 in FIG. 3, with additional output shaft.

FIGS. 6A and 6B show a top view and a side view of an embodiment of the present invention.

FIGS. 7A-7C shows perspective views of a modified input shaft and a piston.

### DESCRIPTION OF THE PREFERRED EMBODIMENT

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides for an improved oil seal design and bearing to replace currently used oil seals. The improved oil seal design and bearing can be used in place of currently used input to output shaft seals. Currently, the input and output shafts of transmissions produce substantial movement relative to each other. Excessive movement between the shafts causes rapid oil seal wear and oil loss problems. The new bearing & oil seal of the present invention may serve to help eliminate the excessive movement between the shafts and provide a vertical sealing face for a more durable seal.

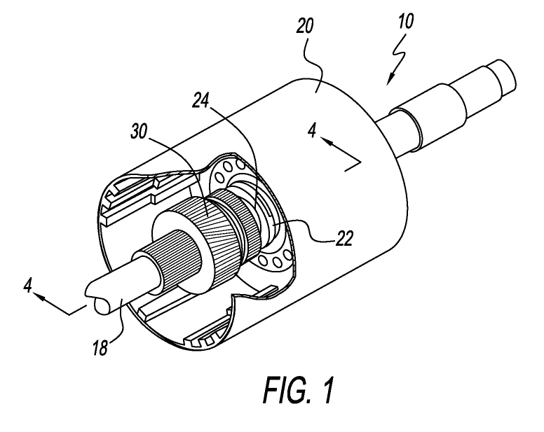

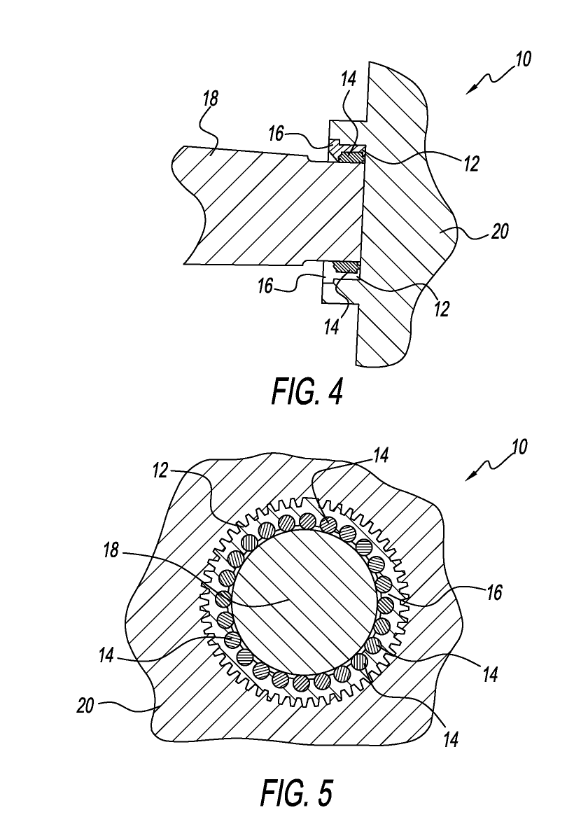

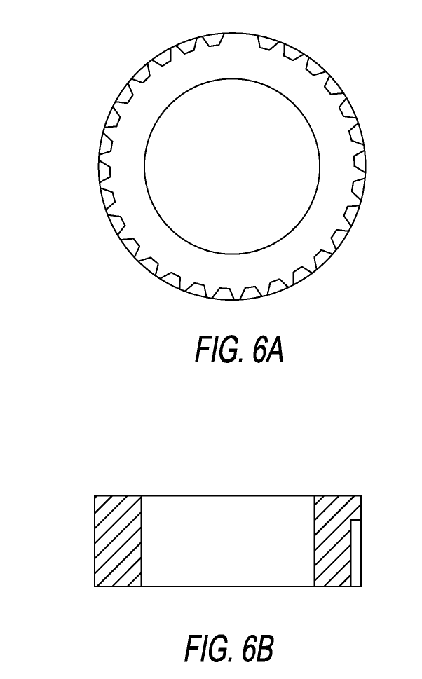

Referring to FIG. 1, there is disclosed a perspective view of an input shaft assembly 20 and output shaft assembly 18 wherein an embodiment of a new bearing/oil seal 10 according to the present invention is installed but is not visible. The new bearing/oil seal 10 uses two vertical faces in contact with each other. One of the vertical faces is the end of the input shaft 20 and the other on the end of output shaft 18 is the actual output shaft. Since both the input 20 and output shafts 18 have constant horizontal movements, one of the vertical sealing faces may need to make constant horizontal movements by using lube oil pressure differential or other means known in the art to keep the vertical faces in contact to make an effective seal. The bearing & vertical seal 16 may replace traditional seals used in transmissions. The sectional view displayed in FIG. 4 and FIG. 5 from different angles help to understand the arrangement/spatial relationship between the bearing & oil seal 10 and the input shaft assembly 20 and output shaft assembly 18. FIG. 6 shows a top view and a side view of the bearing & oil seal 10 with dimensions. The outer and inner diameters of bearing & oil seal 10 are about 1.16 inch and 0.761 inch respectively. The bearing 10 is about 0.385 inch and has about 29 teeth (spines). The bearing 10 can help eliminate the excessive movement between the shafts and provide a vertical sealing face for a more durable seal. The bearing 10 is able to perform multiple functions while only being a single element.

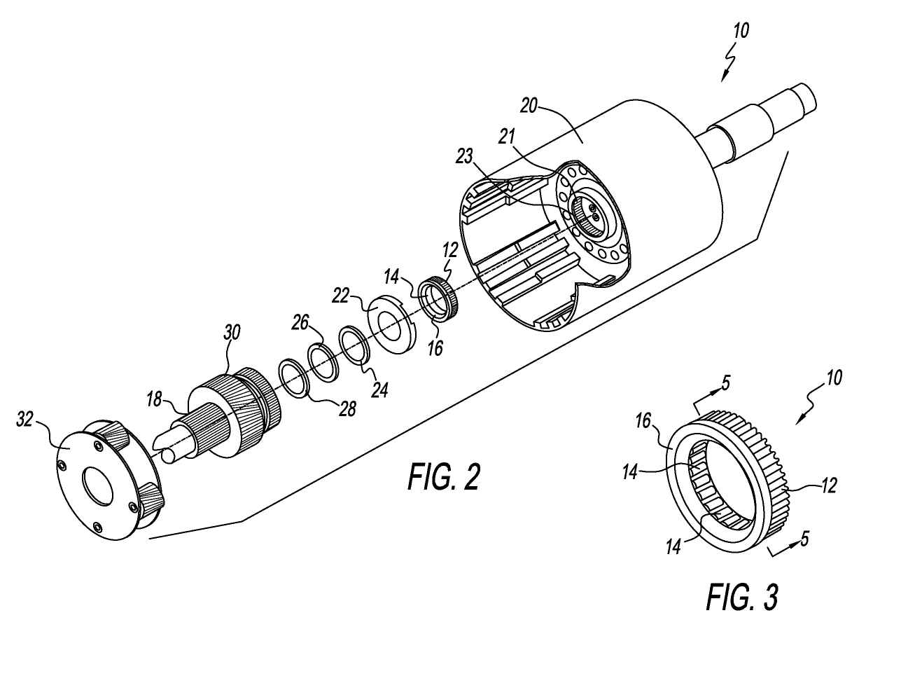

Referring back to FIG. 2, one embodiment of an automatic transmission comprising the new bearing/oil seal 10 of the present invention may further comprise an input shaft assembly 20, a Torrington thrust bearing 22, a nylon seal 24, a wavy spring washer 26, a steel washer 28, a sun gear 30 that may include an output shaft assembly 18, and a planet gear assembly 32.

FIG. 3 shows a perspective view of the embodiment of embodiment of FIG. 2.

FIG. 4 shows a sectional view of the embodiment of the invention taken along line 4-4 in FIG. 1 (the spray assembly has been intentionally omitted for clarity).

FIG. 5 shows a sectional view of the embodiment of the invention taken along line 5-5 in FIG. 3, with additional output shaft.

FIGS. 6A and 6B show a top view and a side view of an embodiment of the present invention.

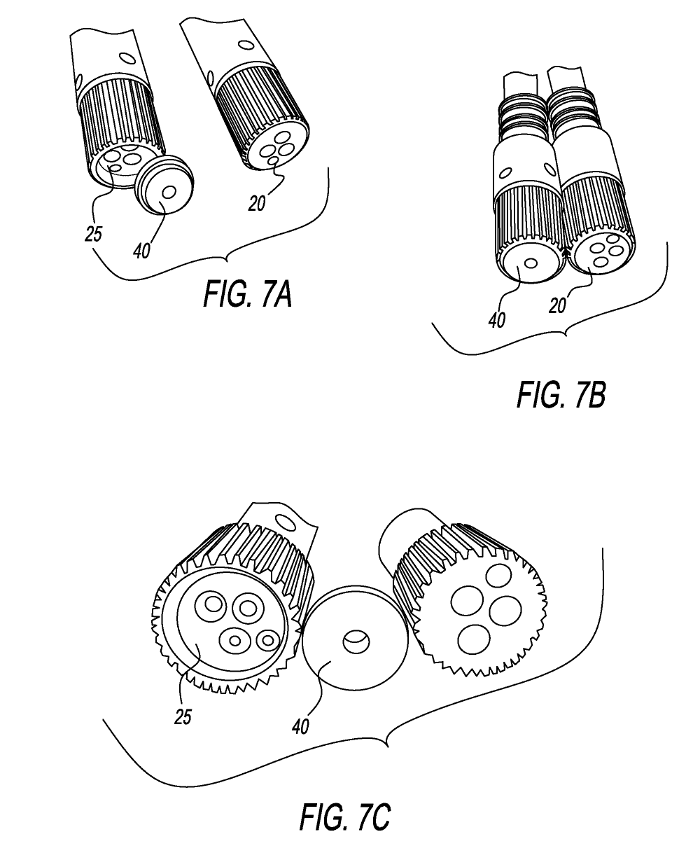

Referring to FIGS. 7A-7C for another embodiment, the end of the input shaft 20 may be modified by boring a hole 25, which is 0.250 in depth and 0.900 inch diameter. In this hole a piston 40 with a center hole would be installed. The piston 40 serves as the vertical face for the input shaft 20. The piston 40 redirects the lube oil passageway in the input shaft 20 to the center of the piston to pass oil into the center of the output shaft 18. The oil pressure differential between the back and front of the piston 40 keeps the vertical surfaces, which are one end of piston 40 and one end of output shaft 18, in close contact, making an effective seal. The pressure differential is due to the orifices in the output shaft 18, thus the piston 40 has force at all times on the vertical faces.

The bearing & oil seal 10 can be employed during rebuilding of transmissions or during the initial manufacture thereof. In some embodiments, the new bearing/oil seal 10 is installed on the GM700r4 family of transmissions. The new bearing/oil seal 10 will reduce bearing wear on input and output shafts, increase new vertical oil seal life, transmission and clutch life, and provide better lubrication and cooling. Additionally, the use of the new bearing/oil seal 10 will simplify the manufacturing and or repair process of transmissions. The bearing/oil seal 10 can replace the oil seals and bearings, currently used in transmissions with one element. The bearing/oil seal 10 can connect and serve as a seal for the input shaft 20 and the output shaft assembly 18, while reducing the movement there between. In other embodiments, the oil seal can be provided without the bearing, and the oil seal would work to provide and effective seal.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A GM 700R4 automatic transmission comprising a highly durable bearing/oil seal design for coupling input shaft and output shaft to help control movement of both input shaft and output shaft and provide vertical oil seal so as to reduce the automatic transmission breakdown.

2. The GM 700R4 automatic transmission of claim 1 wherein the highly durable bearing/oil seal design includes a plurality of bearings located on its inner circumference; a plurality of spines located on its outer circumference; and a bearing seal located about its outer circumference; wherein the plurality of bearings are in contact with the output shaft assembly, the plurality of spines are located in the plurality of linear grooves in the input shaft, and the bearing seal is located in and corresponds to the circular groove in the input shaft.

3. The GM 700R4 automatic transmission of claim 1 wherein the highly durable bearing/oil seal design can be employed during rebuilding of transmissions or during the initial manufacture thereof.

4. The GM 700R4 automatic transmission of claim 2 wherein the highly durable bearing/oil seal design has 29 spines located on its outer circumference.

5. The GM 700R4 automatic transmission of claim 2 wherein the inner and outer diameters of the highly durable bearing/oil seal design is about 0.761 of an inch, the outer diameter is about 1.16 inches, and the height is about 0.385 of an inch.

6. A GM 700R4 automatic transmission with reduced oil loss and breakdown comprising:
an input shaft assembly;
an output shaft assembly; and
a highly durable bearing/oil seal design for coupling input shaft and output shaft to help control movement of both input shaft and output shaft and provide vertical oil seal so as to reduce automatic transmissions breakdown.

7. The GM 700R4 automatic transmission of claim 6 wherein the input shaft assembly has a circular groove and a plurality of linear grooves.

8. The GM 700R4 automatic transmission of claim 7 wherein the highly durable bearing/oil seal design includes
a plurality of bearings located on its inner circumference;
a plurality of spines located on its outer circumference; and
a bearing seal located about its outer circumference;
wherein the plurality of bearings are in contact with the output shaft assembly, the plurality of spines are located in the plurality of linear grooves in the input shaft, and the bearing seal is located in and corresponds to the circular groove in the input shaft.

9. The GM 700R4 automatic transmission of claim 8 wherein the highly durable bearing/oil seal design has 29 spines located on its outer circumference, and has an inner diameter of about 0.761 inch, an outer diameter of about 1.16 inches, and a height of about 0.385 inch.

10. The GM 700R4 automatic transmission of claim 6 wherein the input shaft assembly further has a hole wherein a piston with a center hole is installed.

11. The GM 700R4 automatic transmission of claim 10 wherein the input shaft assembly is modified by boring a hole of about 0.25 inch in depth and about 0.90 inch in diameter wherein a piston with a center hole is installed; said piston serves as the vertical face for the input shaft; said piston redirects the lube oil passageway in the input shaft to the center of the piston to pass oil into the center of the output shaft; the oil pressure differential between the back and front of the piston keeps the vertical surfaces, which are one end of piston and one end of output shaft, in close contact, making an effective seal; and the pressure differential is due to the orifices in the output shaft, wherein the piston has force at all times on the vertical faces.

12. A method of modifying a GM 700R4 automatic transmission having an OEM input to output oil seal comprising: removing the OEM input to output oil seal; modifying the input shaft if necessary to receive a new bearing/oil seal of the present invention in the place of OEM input to output oil seal; and coupling both input shaft and output shaft to control movement of both shafts.
